(19) United States
(12) Patent Application Publication
(10) Pub. No.: US 2007/0210074 A1
(43) Pub. Date: Sep. 13, 2007

(54) SURFACE HEATING ELEMENT AND METHOD FOR PRODUCING A SURFACE HEATING ELEMENT

(76) Inventors: Christoph Maurer, Zuerich (CH); Peter Katzenbach, Heiden (CH); Marcel Strotz, Siebnen (CH)

Correspondence Address: HOFFMAN WARNICK & D'ALESSANDRO, LLC, 75 STATE STREET, 14TH FLOOR, ALBANY, NY, 12207, US

(21) Appl. No.: 11/677,711

(22) Filed: Feb. 22, 2007

(30) Foreign Application Priority Data
Feb. 24, 2006 (EP) 06003792.6

(51) Int. Cl. H05B 3/54

(52) U.S. Cl. 219/549

(57) ABSTRACT

The invention relates to a surface heating element comprising a fabric, which has electrically conductive and electrically non-conductive threads. Several electrically conductive threads are joined together to a heating strip, in which case different heating strips can be wired in any chosen way. Moreover, the invention relates to a method for producing such a surface heating element.

### BACKGROUND OF THE INVENTION

1. Field of the Invention

The invention relates generally to surface heating elements. More specifically, the present invention is directed to a surface heating element comprising a fabric which has threads in the weft and warp direction, wherein at least some of the threads are designed as electrically conductive threads.

Furthermore, the invention relates to a method for producing a surface heating element, in which a fabric is woven consisting of threads, which are, at least in part, electrically conductive threads.

2. Related Art

Surface heating elements are employed for seat heaters in automotive vehicles for example. To this end wire bundles, so-called stranded wires, are usually stitched onto a textile. These stranded wires extend spirally or helically on the carrier material and consist in most cases of a single continuous conductor, which is then arranged across the entire surface of the carrier material. For the heat production a voltage is applied to the ends of the conductor. Through the resistance of the stranded wire and the current flowing through, heat is generated for use in heating the seat. On the one hand the stitching-on of the wire requires a lot of work and on the other hand it turns out to be extremely difficult to attain a uniform heating effect across the entire surface of the carrier material.

Another problem arising in connection with the use of stranded wires is that in some parts of the resultant surface heating element overheating may occur. This can most often be ascribed to wire bundles that are placed too close to each other. In part this can also be caused by the fact that the stitched-on stranded wires tend to slide so that the distances and the precise positioning of the stranded wire to the adjoining wire cannot be kept exactly constant.

Furthermore, the carrier material with the stitched-on wire bundles has a low flexibility, since the wires have a relatively large diameter. Consequently, the placing inside or on the upholstery of seats is highly difficult. In addition, in most cases an electric insulating layer is provided on the carrier material so as to prevent short circuits or other kinds of leakages of the heating current. Through this insulating layer the flexibility is deteriorated further.

Another possibility of producing a seat heating is described for instance in DE 42 33 118 A1. Here a fabric is used as a heating blanket consisting of carbon fibers that have a relatively high electrical resistance. To supply a current to this heating blanket lead-in or contact wires are each provided at the ends. One of the contact wires is earthed, while another is acted upon by voltage. As a result of the difference of potential a current flows via the carbon fibers of the fabric to the earthed contact wire and thereby produces heat.

Theoretically, such a heating blanket permits a uniform constant heat emission over the entire surface. However, a concentration of the heat production at specific locations is not possible with this heating blanket. In addition, there is the problem that the demands made on the carbon fiber fabric with regard to uniformity are very high in order to achieve a really uniform heat distribution.

Another surface heating element is disclosed in DE 41 36 425 A1. Here sinusoidal weft threads are provided in a knitted textile base material, that function as heating conductors. To supply power to these heating conductors power-supply conductors are provided, to which the heating conductors are connected. As described, particular attention must be paid to the contacting of the heating conductors with the power-supply conductors. This is endeavored to be achieved by means of a long contact path. A mechanical connection of the heating conductor with the power-supply conductors is deliberately not taken into consideration.

### SUMMARY OF THE INVENTION

The invention provides a surface heating element and a method for producing a surface heating element, which is particularly efficient and can be dimensioned and used in a flexible way.

A surface heating element in accordance with the invention is characterized in that at least two heating strips are provided, wherein each heating strip is formed by a group of electrically conductive threads that extend in a mutually spaced manner. Furthermore, provision is made for the electrically conductive threads of each group to be electrically connected at a starting portion and an end portion through a planar connecting device and for the heating strips to be electrically wired to one another via connecting means.

A fundamental idea of the invention resides in the fact that a number of individual electrically conductive threads are joined to heating strips and that in this way they are contacted jointly. By joining several adjacent electrically conductive threads that extend in a mutually spaced manner this offers the advantage on the one hand that, should a disconnection of a thread occur, this does not lead to a complete interruption of the circuit. This is the case in conventional seat heaters with a spirally placed stranded wire when the stranded wire is interrupted at a location. On the other hand, even in the case of failure of some of the electrically conductive threads of a heating strip it is possible to achieve a sufficient heat production. Hence, for the heating effect it is of no account if one of e.g. thirty-six conductive threads of a heating strip is defective.

Another advantage resulting from the use of heating strips is that much thinner single wires can be employed. As known, the resistance of a conductor increases upon a reduction of its diameter. Consequently, when using very fine electrically conductive threads the problem arises that even at low voltage the resistance becomes so high that overheating and eventually melting of such a conductor or thread is likely to happen. However, the use of very thin threads as conductors proves to be of advantage for a highly flexible surface heating element, because with thicker conductors the entire flexibility of the fabric to be produced is diminished considerably. If several thin conductors are joined in a parallel fashion to a heating strip, the absolute resistance of such a heating strip is reduced so that the resultant heating strip has a lower resistance than the individual conductive threads. Therefore, due to the lower resistance less heat is produced. As a result, the risk of a melt-through of conductors is reduced to a large extent.

Since the failure of one or two conductors does not have any significant effect on the resistance of the heating strip when a great number of conductors for example in the order of forty is provided in a heating strip, such a construction also brings about a low susceptibility to defects with regard to a change of the total resistance.

A further fundamental idea of the surface heating element according to the invention resides in the fact that the electrically conductive threads of each group are electrically connected at a starting portion and an end portion through planar connecting means. These connecting means can also serve for a mechanical connection. By means of the connecting means that are applied to the fabric the contacting of the individual conductive threads of a heating strip is facilitated considerably and carried out in a more reliable way as compared to leads introduced into the fabric.

Another fundamental idea realized by the surface heating element according to the invention resides in the possibility of wiring different heating strips in a varying fashion through the planar connecting means. For instance it is possible to wire several heating strips parallel to one another in order to attain an increased protection against failures. In addition, the resistance and consequently the heat generation of the resultant surface heating element can also be determined thereby. If several heating strips are connected in series for example, the resistance rises and the overall heating effect is increased.

In principle, it is not necessary for the electrically conductive threads to have an insulation. However, during the further processing of the surface heating element in accordance with the invention it has proved to be advantageous if the electrically conductive threads have an insulation along their external surface. This can be realized for example in the form of a thin insulating varnish coating. Through the insulation of the individual electrically conductive threads it is possible to place these closer to one another in a heating strip without any risk of these coming into contact with one another. A contact or alternatively a rubbing of several electrically conductive threads is not desired, as this might lead to conductive bridges that can have an influence on the resistance of a heating strip and therefore also on its heating effect. Moreover, at such points of contact there is an increased risk of the electrically conductive threads burning through.

In the case of an insulated design of the conductive threads it is unnecessary to cover the surface heating element with a fleece or a similar damming or insulating material if it is built into a seat for example. As a result, this saves material and also weight on the one hand and on the other hand the heat generated by the surface heating element can be emitted in a better way and is not diminished by an additional insulating material.

In an advantageous embodiment of the heating element the mesh width is constant across the surface of the fabric. Moreover, provision is made for the distance between adjacent electrically conductive threads and/or between heating strips to be variable. Thus, through the number of electrically conductive wires responsible for the generation of heat it is possible to influence the heating effect per surface unit. Likewise, the heating effect can be varied and determined through the distance of the individual heating strips with respect to one another.

A constant mesh width across the surface of the fabric serves, among other things, to impede a mutual displacement of the electrically conductive threads. To this end a mesh aperture e.g. in the range of approximately 0.1 mm only is provided. Accordingly, filigree threads with an extremely small diameter are used. To determine the heating effect for example only every second or third weft thread can be an electrically conductive thread. Here the number of non-conductive threads between the electrically conductive threads can be varied as desired. In order to attain a particularly high surface heating effect the exclusive use of electrically conductive threads is also possible.

The dimensions of the electrically conductive and electrically non-conductive threads do not have any influence on the basic concept of the surface heating element according to the invention. However, during production and with regard to the durability in continued operation, it has proved to be of advantage if the electrically conductive threads and the electrically non-conductive threads are substantially of the same diameter. In this way an extremely even fabric can be produced that is not subject to additional stress due to threads of varying degrees of thickness.

In a further embodiment the diameter of the threads lies in particular in a range between 10 μm and 100 μm. A diameter lying in the range from 50 μm to 60 μm, more particularly around 40 μm, is particularly preferred. This dimensioning permits an extreme fineness of the fabric to be produced, while the wires possess sufficient stability to resist mechanical stress. Basically, it is also possible to employ finer threads, in which case additional stabilizing threads might perhaps be introduced in order to absorb mechanical stress. By using the fine threads the extremely high flexibility of the fabric is achieved.

The material of the conductive threads can consist of any chosen electrically conductive material. For example use can be made of metals, alloys, electrically conductive plastics or carbon fibers. It is particularly advantageous to use copper wires as electrically conductive threads. Copper has the advantage, among other things, that the specific resistance of a wire produced therefrom is very constant across the entire length and can also be determined in a highly precise manner. As electrically non-conductive threads use can be made e.g. of plastics or natural fibers. More favorably, polymers, such as polyester, can be used. With the very small diameters provided here these materials have a high stability with respect to both mechanical stress and heat generated by the electrically conductive wires.

In principle, it is possible to connect the single electrically conductive threads or the heating strips by means of additional line wires woven into the fabric. However, since they serve as current supply and discharge lines, they should have a larger diameter than the remaining threads included in the fabric, which has an effect on the production and the load-bearing capacity of the fabric. What is more, when supply and discharge wires are used the problem of contact arises, which has already been dealt with in prior art.

It is therefore particularly preferred to connect the planar connecting device with the heating strips, i.e. with the electrically conductive threads, through compression and heat. For this purpose a so-called thermo-compression welding can be employed, in which no further materials are required for the connection. Such a welding-type connection of the connecting means with the electrically conductive wires has a good electrical transmitting capacity and can be integrated in a relatively easy way into a production process. In addition, this brings about a good electrical transmitting capacity between the connecting means and the electrically conductive wires. However, other contacting methods, such as soldering or adhesion with conductive adhesives, are basically possible, too.

When designing the planar connecting means it has proved to be of advantage to design these as thin conductive portions of flexible printed circuit boards. The conductive portions can be produced for example of a metallic material, whereby the thermo-compression welding is facilitated. Basically, any other electrically conductive material is suitable for this, also. As thin flexible printed circuit boards use can be made of Flexprint for example. This consists of a plastic-like carrier layer that has a conductive coating. To define individual conductive portions the conductive material can be etched away at certain parts. However, it is also possible to use individual separate conductive lamina only. Through the positioning of the conductive portions of the printed circuit boards single heating strips can be wired selectively to one another. In addition, over these thin printed circuit boards a cover and/or insulating tape can additionally be placed for instance in an adhesive manner. This tape serves to mechanically stabilize and protect the points of contact between the thin printed circuit boards or their conductive portions and the electrically conductive wires. The cover tape can be made e.g. of plastic in the form of a plastic film. This tape can be self-adhering in order to facilitate the attachment.

The planar connecting means can also be provided for example in the form of a thin metal tape, which is interrupted in parts to form a printed circuit board.

In the description so far the term threads has been mentioned. These threads that are introduced in the weft and warp direction can be both monofilament and multifilament threads. In a preferred embodiment monofilament threads are especially used for the electrically conductive threads, because in this way the diameter of the threads can be determined particularly well and consequently the resistance presented by them can be determined more precisely.

In a particularly advantageous embodiment the surface heating element is used to constitute a seat heating e.g. in an automotive vehicle. Compared to seat heaters such as the ones used in prior art the surface heating element has a considerably lower weight and can be processed in a particularly easy way on account of its high flexibility and tensile strength. Likewise, with the surface heating element according to the invention it is possible in an especially simple manner to set and achieve different surface heating effects as desired.

Surprisingly, it has been determined that with the same expenditure of energy a surface heating element according to the invention reaches the desired heat as early as after approximately 45 seconds, whereas conventional seat heaters require at least 3 minutes for this. Amongst other things, this can be attributed to the improved distribution of the heat-generating fibers over the entire fabric surface. The good and precise positioning of the electrically conductive threads also allows for a very precise determination of the location of the heating effect and for a particular evenness of heating. Likewise, the omission of additional insulating fabric is also of significance here.

Moreover, as a result of the extremely light-weight and flexible surface heating element the basic weight of a seat heating is reduced. The power generated by the surface heating element according to the invention can lie in the range of up to 100 kW/kg, which is better by far than in known seat heaters.

A method according to the invention for producing a surface heating element is characterized in that at least two heating strips are formed, which are each joined together of a group of electrically conductive threads that extend in a mutually spaced manner. Furthermore, the electrically conductive threads of each group are electrically conductively connected at a starting portion and an end portion through a planar connecting device and the heating strips are electrically wired to one another via the connecting means.

A fundamental idea of the method in accordance with the invention is to improve the failure safety of a surface heating element, since several electrically conductive threads that lie adjacent to one another are joined to heating strips. Thus, single electrically conductive threads can be defect without this having any considerably influence on the entire system.

Another fundamental idea can be seen in the fact that the use of external connecting means permits on the one hand a particularly good contacting of the individual conductive threads. On the other hand the connecting means render it possible that the individual heating strips can be wired to one another as desired. Hence, through selective parallel, series or other combinational connections the total resistance of the surface heating element and consequently the heating effect can be influenced deliberately.

When producing the surface heating element it is especially advantageous for the electrically conductive threads to have an electric insulation along their external surface. This insulation is removed in the portion of the connecting means when they are applied so that a good electrical transmission between the connecting device and the electrically conductive threads is ensured. In principle, though, such kind of insulation is not necessarily required. The insulation has the advantage that the electrically conductive threads are insulated from one another, whereby an undesired mutual contacting of the wires, accompanied by corresponding flowing currents or creeping currents, is prevented or largely minimized. As a result, an undesired burning of the wires caused by a great amount of heat is prevented to a large extent.

Basically, the application of the planar connecting means onto the electrically conductive threads can be carried out with any chosen method, as long as an electrically conductive contact is provided. However, it has proved to be especially advantageous if this connection is produced through the application of compression and heat so that the planar connecting means are welded to the threads. In this method step provision is made for an insulation of the threads that is possibly provided to be removed in the portion of the point of contact. This can be carried out for example through the heat used for welding so that the insulation evaporates or disintegrates. Generally, a previous removal of the insulation, for instance by means of appropriate acids or mechanical auxiliary means, is also possible and here the contacting of the electrically conductive threads can be achieved through soldering and adhesion.

In another advantageous embodiment provision is made for the planar connecting means to be arranged in a mutually spaced manner along a tape and for this tape with the planar connections to be applied to the fabric, in which case the tape lies on the side of the planar connecting means facing away from the fabric. This can be realized e.g. in the form of a thin, flexible printed circuit board, such as Flexprint. Here a thin conductive film is applied to a carrier material. To determine conductive portions a part of the conductive film is removed. By additionally using a cover tape, which can be applied to the fabric e.g. in an adhesive manner, it is possible to protect the planar connecting means themselves and perhaps also the entire thin, flexible printed circuit board and to increase the mechanical stability of the surface heating element in the area of the points of contact.

Moreover, a displacement of the electrically conductive threads at the planar connecting means is prevented and the electrically conductive connection between connecting device and electrically conductive thread is supported. It is of particular advantage if the planar connecting portions are applied to a tape, such as Flexprint, and if conductive portions are defined by an etching method. Afterwards, the connection of the planar connecting means to the electrically conductive threads can be implemented through thermo-compression welding. Before or after this a cover tape is placed onto the prepared fabric and attached adhesively for example.

In doing so the possibility arises of conditioning the planar connecting device in the desired size and to implement a desired wiring of the different heating strips to one another.

To determine the heating effect of the surface heating element to be produced various methods can be employed. For instance use can be made of electrically conductive threads that have a different specific resistance in order to thereby influence the heating effect. Likewise, it is possible to vary the diameter of the electrically conductive threads so as to influence the resistance and therefore the heat generation. Another preferred method resides in the variation of the distance of adjacent electrically conductive threads. Thus, by providing several electrically conductive threads directly next to one another a high surface heating effect can be attained, whereas if a number of electrically non-conductive threads is provided between several electrically conductive threads lying adjacent to one another, the surface heating effect can be reduced.

However, it is equally possible to employ electrically conductive, insulating threads in an intersecting manner, as for example in the weft and warp direction. Here a wiring was implemented as described, except for the fact that two separate heating elements would be formed that can be controlled individually. Therefore, one heating element would be provided in the weft direction and a second, independent one in the warp direction, as no connection between weft and warp threads exists.

### BRIEF DESCRIPTION OF THE DRAWINGS

The invention will be described further by way of preferred embodiments, which are shown schematically in the drawings.

FIG. 1 shows a view of an extremely simplified structural example of a surface heating element according to the invention.

FIG. 2 shows a view of a simplified surface heating element according to the invention to be installed for a seat heating.

### DETAILED DESCRIPTION OF THE INVENTION

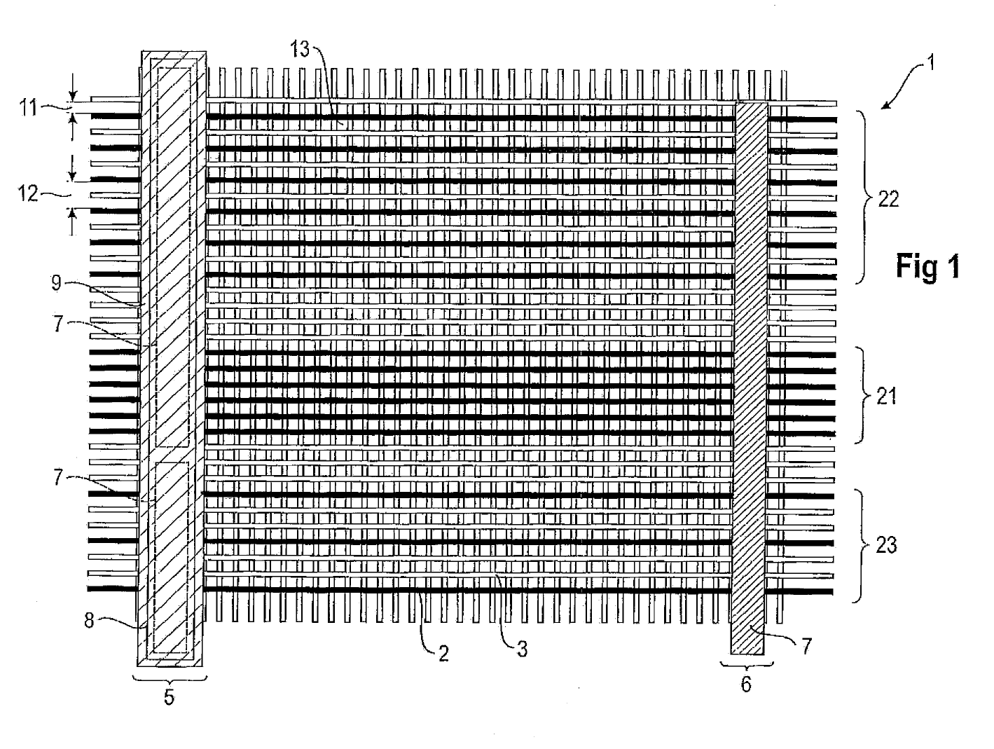

In FIG. 1 an extremely simplified structural example of a surface heating element 1 in accordance with the invention is shown. The surface heating element 1 has a fabric which is formed of weft and warp threads in the embodiment illustrated here. To this end electrically conductive threads 2 and electrically non-conductive threads 3 are used. In the embodiment depicted here the electrically conductive threads 2 are only used in the weft direction. It is also possible to provide electrically conductive threads in the warp direction only or both in the weft and warp direction.

In the cutaway part of the fabric illustrated three different kinds of heating strips 4 are shown by way of example. The heating strip I 21 has the highest surface heating effect compared to the other two heating strips II 22 and III 23. In the heating strip I 21 the electrically conductive threads 2 are positioned directly adjacent to one another so that substantially they run parallel to one another.

By comparison, in the heating strip II 22 an electrically non-conductive thread 3 is provided between each electrically conductive thread 2. Hence, in comparison to the heating strip I 21, the heating effect is reduced in relation to the surface. The surface heating effect of the heating strip III 23 is even more reduced due to the fact that further electrically non-conductive threads 3 are introduced between the electrically conductive threads 2. Basically, even more electrically non-conductive threads 3 than depicted in FIG. 1 can be introduced between the electrically conductive threads 2 in order to further reduce the surface heating effect of a heating strip 4.

The individual electrically conductive threads 2 of a heating strip 4 are connected to one another through a planar connecting device 7. This planar connecting device 7 also serves to wire single heating strips to one another in a desired manner. In the end portion 6 of the fabric 13 a planar connecting device 7 is shown without cover tape 9 and printed circuit board 8. The planar connecting device 7 can be designed as a thin plate, e.g. as a thin copper plate.

In the starting portion 5 the connecting elements 7 or the printed circuit boards 8 are covered by the cover tape 9. The planar connecting means 7 are formed on a printed circuit board 8. The position of the printed circuit boards 8 is illustrated by the continuous line and that of the planar connecting device 7 is illustrated by the dotted contour. The cover tape 9 can be applied e.g. adhesively onto the printed circuit board 8, which is attached already, and on the fabric 13. It is also possible to first place the printed circuit board 8 onto the cover tape 9 and then to attach the cover tape 9 with the printed circuit boards 8 and the connecting means 7 to the fabric 13. The cover tape 9 can additionally serve as insulation of the printed circuit boards 8 for example. However, the printed circuit board 8 is not necessarily required.

The attachment of the connecting means 7 to the fabric 13, and in particular to the electrically conductive threads 2, can be carried out by means of thermo-compression welding. In this kind of connection an electrically conductive connection is established through compression and heat between the electrically conductive threads 2 and the connecting means 7 that are designed as conductive portions of the printed circuit boards 8. The result is a “micro”-welding of a conductive thread 2 with the conductive portions.

If the electrically conductive threads 2 are sheathed with an insulating layer, this layer can be removed during thermo-compression welding for example through the effect of the heat. The insulation of the electrically conductive threads 2 can serve on the one hand as a protection against undesired mutual contact of the threads and on the other hand to facilitate the installation of a surface heating element according to the invention e.g. into a seat heating, since an additional insulation, such as a specific layer of insulating fabric, is no longer required.

The cutaway part of a surface heating element 1 according to the invention shown in FIG. 1 is an extremely enlarged illustration. With a diameter of the threads 2, 3 lying in the range of 40 μm, a mesh aperture 11 of approximately 0.1 mm is provided. Such a surface heating element includes between 10 and 200 threads per centimeter, more preferably between 150 and 60, and in particular approximately 70 threads per centimeter.

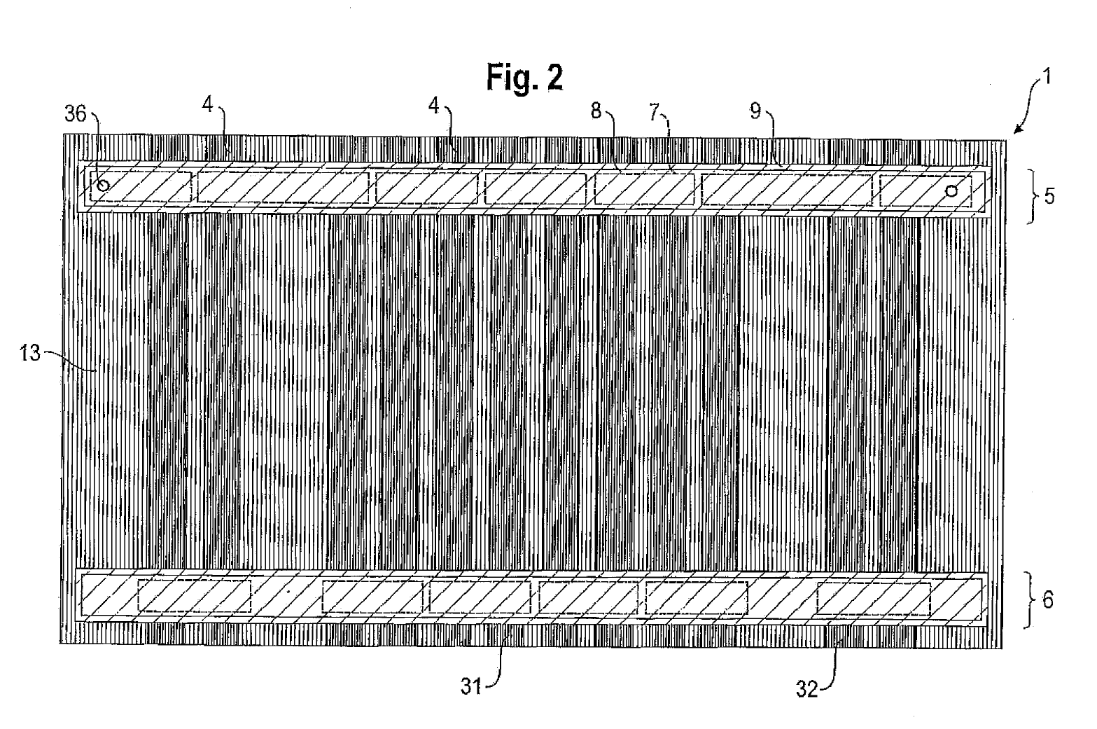

In FIG. 2 a simplified surface heating element 1 according to the invention is shown, which is provided for installation into the seat of an automotive vehicle. The surface heating element 1 has two different heating strips A 31 and B 32. Both heating strips 31, 32 have a different surface heating effect as a result of electrically conductive threads 2 that are positioned in varying proximity to one another. In the case of the surface heating element 1 depicted here the density and number of threads 2, 3, of which the fabric 13 consists, ranges from 3000 to 4000 threads for an automotive vehicle seat, with the total length of the surface heating element 1 lying in a range of 40 to 50 cm only. In a heating strip A 31 for example approximately 110 threads are provided.

Between the individual heating strips 31, 32 portions without electrically conductive threads 2 are present. These portions serve on the one hand for a better segregation of the heating strips 4 with respect to one another, and on the other hand they are provided for those parts in which the upholstery is, for example, fixed. This is the case with grooves present in the upholstery that are not supposed to be heated in order to avoid an unnecessary waste of energy as well as overheating.

In the surface heating element 1 shown the individual heating strips 4 are connected in series to one another. The individual connecting means 7 of the printed circuit boards 8 are again shown in dotted lines. The printed circuit board 8 itself is illustrated as a continuous line. At the beginning and end of the upper cover tape 9 a connecting point 36 is provided respectively for connection to the power supply. The surface heating element 1 depicted in a sketch-like manner here is designed for connection to an automotive on-board power supply, preferably lying in a range of 12 V. However, due to the flexibility in dimensioning the individual heating strips 4 themselves and in wiring the individual heating strips 4 to one another, the adaptation to other voltages is also quite easily possible.

The surface heating element in accordance with the invention is equally suitable for applications other than a seat heating. It is also conceivable to provide the surface heating elements in clothes so as to warm them. Likewise, it is possible to install the surface heating element according to the invention into skiing boots for example in order to warm them up to an agreeable temperature prior to use.

The surface heating element according to the invention permits an easy, flexible and highly effective use of surface elements, as for example for seat heaters.

The foregoing description of the embodiments of this invention has been presented for purposes of illustration and description. It is not intended to be exhaustive or to limit the invention to the precise form disclosed, and many modifications and variations are possible.

1. A surface heating element, comprising:
a fabric comprising threads in a weft and warp direction, wherein at least a portion of the threads comprise electrically conductive threads, the fabric comprising:
at least two heating strips, wherein each heating strip comprises a group of the electrically conductive threads that extend in a mutually spaced manner, wherein the electrically conductive threads of each group are electrically connected at a starting portion and an end portion by a planar connecting means, and wherein the heating strips are electrically wired to one another via the planar connecting means.

2. Surface heating element according to claim 1, wherein the electrically conductive threads have insulation along an external surface.

3. Surface heating element according to claim 1, wherein a mesh width is constant across a surface of the fabric and a distance between adjacent electrically conductive threads and/or heating strips is varied in order to influence a heating effect.

4. Surface heating element according to claim 1, wherein the electrically conductive threads in the fabric have substantially a same diameter as electrically non-conductive threads in the fabric.

5. Surface heating element of claim 4, wherein the diameter of the electrically conductive threads falls in a range of between about 10 μm and about 100 μm.

6. Surface heating element of claim 5, wherein the diameter of the electrically conductive threads falls in a range of between about 40 μm and 50 μm.

7. Surface heating element according to claim 1, wherein the electrically conductive threads comprise copper wires, and wherein the electrically non-conductive threads comprise a polymer.

8. Surface heating element according to claim 7, wherein the polymer comprises polyester.

9. Surface heating element according to claim 1, wherein the planar connecting means is connected to the heating strips through compression and heat.

10. Surface heating element according to claim 9, wherein the compression and
heat are provided using thermo-compression welding.

11. Surface heating element according to claim 1, wherein the planar connecting means comprise planar thin plates, wherein the planar connecting means are arranged in a mutually spaced manner along a tape, and wherein the planar thin plates are arranged on the fabric and electrically connected with the electrically conductive threads.

12. A seating heating system, comprising:
a surface heating element, the surface heating element comprising:
a fabric comprising threads in a weft and warp direction, wherein at least a portion of the threads comprise electrically conductive threads, the fabric comprising:
at least two heating strips, wherein each heating strip comprises a group of the electrically conductive threads that extend in a mutually spaced manner, wherein the electrically conductive threads of each group are electrically connected at a starting portion and an end portion by a planar connecting means, and wherein the heating strips are electrically wired to one another via the planar connecting means.

13. Method for producing a surface heating element, comprising:
weaving a fabric comprising threads, wherein at least a portion of the threads comprise electrically conductive threads; and
forming at least two heating strips, wherein each heating strip comprises a group of the electrically conductive threads that extend in a mutually spaced manner, wherein the electrically conductive threads of each group are connected in an electrically conductive manner at a starting portion and an end portion through a planar connecting means, and wherein the heating strips are electrically wired to one another via the planar connecting means.

14. Method according to claim 13, wherein the electrically conductive threads have electric insulation along an external surface, further comprising:
removing the insulation at the starting and end portions of the electrically conductive threads connected to the planar connecting means.

15. Method according to claim 13, further comprising:
applying the planar connecting means to an insulated portion of the electrically conductive threads; and
welding the planar connecting means to the electrically conductive threads through an application of compression and heat, wherein the insulation of the electrically conductive threads is removed at the weld.

16. Method according to claim 13, further comprising:
arranging the planar connecting means in a mutually spaced manner along a tape; and
applying the tape with the planar connecting means to the fabric, the tape lying on a side of the planar connecting means facing away from the fabric.

17. Method according to claim 13, further comprising:
varying a distance between adjacent electrically conductive threads to adjust a heating effect.
